(19) United States
(12) Patent Application Publication
(10) Pub. No.: US 2007/0088110 A1
(43) Pub. Date: Apr. 19, 2007

(54) Two-component adhesive/sealant

(76) Inventors: Matthias Kohl, Weinheim (DE); Roland Reichenbach-Klinke, Heidelberg (DE); Patrick Steigerwald, Mannheim (DE); Gisbert Kern, Mannheim-Freudenheim (DE); Manfred Proebster, Nussloch (DE)

Correspondence Address: HENKEL CORPORATION, THE TRIAD, SUITE 200, 2200 RENAISSANCE BLVD., GULPH MILLS, PA, 19406, US

(21) Appl. No.: 11/593,189

(22) Filed: Nov. 3, 2006

Related U.S. Application Data
(63) Continuation of application No. PCT/EP05/04200, filed on Apr. 20, 2005.

(30) Foreign Application Priority Data
May 5, 2004 (DE) 10 2004 022 150.2

(51) Int. Cl. B60C 1/00; C08K 5/24

(52) U.S. Cl. 524/261; 524/492

(57) ABSTRACT

A two part adhesive/sealant composition is provided, wherein component A contains at least one silane-terminated prepolymer, at least one silane crosslinking catalyst, and at least one low molecular weight organofunctional silane and component B contains at least one silane-terminated prepolymer, water and at least one water-dissolving and/or water-adsorbing agent such as an organic or inorganic thickener. Such compositions are exceptionally insensitive to mixing and dosing errors in use and are useful for forming elastic bonds between substrates.

### CROSS-REFERENCE TO RELATED APPLICATIONS

This application is a continuation under 35 USC Sections 365(c) and 120 of International Application No. PCT/EP2005/004200 filed 20 Apr. 2005 and published 17 Nov. 2005 as WO 2005/108520, which claims priority from German Application No. 102004022150.2, filed 5 May 2004, each of which is incorporated herein by reference in its entirety.

### FIELD OF THE INVENTION

This invention relates to a two-component adhesive/sealant based on silane-terminated prepolymers, to a process for its production and to its use for the elastic bonding of two or more substrates of the same and/or different kind(s).

### DISCUSSION OF THE RELATED ART

In the metal-processing industry, in the automotive industry, in the manufacture of utility vehicles and in their supplier industries, identical or different, metallic and non-metallic substrates are often joined together by adhesives/sealants. Various one-component or two-component adhesives/sealants are already available for this purpose. Adhesives/sealants are generally preferred by users because no mixing and dosing errors can occur in use. However, in the bonding of non-porous substrates, the use of one-component moisture-curing adhesives/sealants is seriously limited by the relatively slow cure rate.

Another disadvantage of one-component moisture-curing adhesives/sealants is that their cure rate is highly climate-dependent, i.e., their cure rate is dependent not only on the ambient temperature, but also—and to a far greater extent—on the surrounding atmospheric humidity which, above all in winter months, is very low so that curing is extremely slow, particularly in the bonding of non-porous substrates.

Conventional two-component adhesive/sealant systems contain binders with one type of reactive, crosslinkable groups in one component and, in the second component, binders or hardeners whose functional groups are co-reactive with the reactive groups of the first component. Examples of such adhesive/sealant systems are polyurethane systems with components containing isocyanate groups in one component and binders or hardeners containing amino groups or hydroxyl groups or mercapto groups in the second component. Similarly, traditional two-component epoxy resin systems consist of one component with binders containing epoxy groups while the associated second component contains mercaptan groups or amino groups. The disadvantage of systems such as these is that they are very sensitive to mixing errors because the two components often only develop their optimal hardening and properties when they are completely mixed together in the correct stoichiometric ratio.

Various systems have been proposed for two-component adhesives/sealants with a view to reducing their sensitivity to mixing and dosing errors and still obtaining a fast cure rate less dependent on climatic influences.

EP 0678544 A1 describes two-component adhesive, sealing or coating compounds of a component A and a component D. Component A is said to cure when it comes into contact with water or with component D which contains the hardener for component A. According to the teaching of this document, component D is supposed to be either a component B which contains a constituent that cures on contact with water or even on contact with component A or a mixture of a solid and a volatile constituent which crosslinks component A. The advantage of this two-component system is that component D, although acting as a hardener for component A, either itself cures an excess of component A or does not leave any permanent, troublesome residues behind in the cured compound.

Simpler systems contain moisture-crosslinking binders as component A and water or water-yielding substances and optionally a catalyst as component B. Thus, U.S. Pat. No. 6,025,445 describes a two-component adhesive/sealant system in which component A contains as its main constituent a saturated hydrocarbon polymer with silicon-containing groups which contain hydrolyzable groups bound to the silicon atom and which can be crosslinked to form siloxane groups. Component B contains a silanol condensation catalyst and water or a hydrated metal salt.

WO 96/35761 describes two-component adhesives/sealants based on silane-terminated prepolymers of which component A is a one-component, moisture-curing adhesive/sealant with high early strength and of which component B is a crosslinking agent and/or accelerator for component A. In particularly preferred embodiments, component B is said to consist of a paste-like stable mixture of plasticizers, water, additives and optionally other auxiliaries.

For adhesives/sealants based on polyurethane prepolymers or hybrid systems of polyurethane prepolymers additionally containing reactive silane groups, it has also been proposed to use pastes of water and fillers as an accelerating component for basically moisture-curing binder systems, this water-containing paste being adapted in its viscosity and flow properties to the intended application. The water-containing paste is said to be added to and mixed with the moisture-curing binder component immediately before application of the adhesive/sealant. The documents U.S. Pat. No. 4,835,012 A, U.S. Pat. No. 4,780,520 A, U.S. Pat. No. 4,758,648 A, U.S. Pat. No. 4,687,533 A, U.S. Pat. No. 4,625,012 A and U.S. Pat. No. 4,525,511 A are mentioned by way of example in this regard. One aspect common to all these systems is that component B essentially contains only water or water-yielding substances, optionally fillers, optionally plasticizers and thickeners and optionally catalysts, so that it is inevitably added to the main constituent, the binder component, in only a small quantity. Typical mixing ratios are 100 parts moisture-reactive binder-containing component A to 1 to 5 parts water-containing component A up to a ratio of 10 parts moisture-curing binder component A to 1 part water-containing component B. The disadvantage of these systems is that, when applied by machine, difficulties arise in regard to the dosing and homogeneous incorporation of the minor component B in component A, particularly in view of the extreme mixing ratios. In the case of polyurethane systems, it is even known that homogeneous incorporation is not possible at all, instead the water-containing component B is incorporated in the form of streaks. Apart from the high cost of controlling application by machine, this means that the diffusion of water from the highly “water-enriched” streaks into the binder system to be cured still slows down the cure rate to a significant extent. For 10:1 mixing ratios, cartridge application systems using manually or pneumatically operated cartridge guns are available both for the small user and for the DIY sector. The outlet openings of the two component cartridges are combined via an adapter, the two product streams being mixed in a static mixer. On account of the significant fall in pressure through a static mixer, only short mixing paths are technically possible with the result that it is very difficult to obtain a homogeneous mixture. Accordingly, systems such as these are also only intended for 10:1 mixing ratios and not, for example, for a mixing ratio of 100:2.

EP-A-370463, EP-A-370464 and EP-A-370531 describe adhesive compositions of two or more components, of which one component contains a liquid organic elastomeric polymer with at least one reactive group containing silane groups per molecule and a hardener for an epoxy resin and of which the second component contains an epoxy resin and optionally a hardening catalyst for the elastomeric polymer containing silane groups. The hardeners proposed for the epoxy component are the di- or polyamines, carboxylic anhydrides, alcohols and phenols typically encountered in epoxide chemistry and optionally typical catalysts for the epoxide reaction, such as tertiary amines, salts thereof, imidazoles, dicyanodiamide, etc. Two-component systems such as these have the specific disadvantages of all standard two-component systems: the cure rate and the final properties of the cured adhesives depend to a very large extent on strict adherence to the correct mixing ratio between the components and on the completeness of mixing.

EP-A-520426 describes curable compositions based on silane-containing oxyalkylene polymers which contain hollow microspheres and thus provide for curable compositions of low specific gravity. It is stated in the document in question that these compositions may also be used as two-component systems, one component containing the oxyalkylene polymer containing silane groups, the filler and the plasticizer and the second component containing filler, plasticizer and a condensation catalyst. None of these prior-art documents indicates whether the compositions they disclose have sufficiently high early strength to avoid the need for mechanical fixing immediately after the parts have been joined. In addition, there is no indication of whether component A of these known two-component compositions, which contains the silane-terminated prepolymer, cures completely on its own.

### SUMMARY OF THE INVENTION

Accordingly, the problem addressed by the present invention was to provide two-component adhesives/sealants where preferably both components to be mixed would have to be mixed together in the same ratios by volume and which would not be sensitive to mixing and dosing errors in use.

The invention provides an adhesive/sealant composition consisting of:
a) a component A containing at least one silane-terminated prepolymer, at least one catalyst for the silane crosslinking, low molecular weight and organofunctional silanes; and
b) a component B containing at least one silane-terminated prepolymer, water and water-dissolving or water-absorbing agents.

### DETAILED DESCRIPTION OF CERTAIN EMBODIMENTS OF THE INVENTION

Silane-terminated prepolymers in the context of the present invention are polymers with molecular weights in the range from 1,000 to 50,000 which contain at least one reactive terminal group corresponding to the following formula: 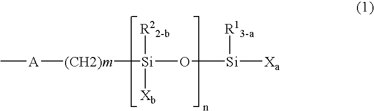
in which A is a 1.5- to 4-functional residue of a polyether, polyester, (meth)acrylate polymer, polybutadiene or polyisobutylene, n is an integer of 0 to 4, m is an integer of 1 to 3 and the substituents R¹ to R² can represent a non-hydrolyzable C₁₋₄ alkyl group and the substituent X can be a hydrolyzing alkoxy group, acetoxy group, oxime ether group, amide group, enoxy group or a hydroxyl group, a=1 to 3 and b=0 to 2. In a preferred embodiment, at least two of the substituents X are hydrolyzable, i.e., a and/or b=at least 2.

The production of moisture-curing compositions containing reactive silane groups curable at room temperature from acrylate or methacrylate derivatives is described, for example, in JP-B-84/78221, JP-B-84/78222, U.S. Pat. No. 4,491,650, EP-A-265929 and U.S. Pat. No. 4,567,107.

In principle, the particularly preferred silane-terminated prepolymers based on polyethers can be produced by various methods:
hydroxyfunctional polyethers are reacted with unsaturated chlorine compounds, for example allyl chloride, in an ether synthesis to form polyethers containing terminal olefinic double bonds which, in turn, are reacted with hydrosilane compounds containing hydrolyzable groups, such as HSi(OCH₃)₃ for example, in a hydrosilylation reaction carried out in the presence of Group 8 transition metal compounds as catalysts to form silane-terminated polyethers;
in another process, the polyethers containing olefinically unsaturated groups are reacted with a mercaptosilane, such as 3-mercaptopropyl trialkoxysilane for example;
in another process, hydroxyfunctional polyethers are first reacted with di- or polyisocyanates which, in turn, are reacted with aminofunctional silanes or mercaptofunctional silanes to form silane-terminated prepolymers.

Another possibility is to react hydroxyfunctional polyethers with isocyanatofunctional silanes, such as 3-isocyanatopropyl trimethoxysilane for example. Instead of 3-isocyanatopropyl trimethoxysilane, the corresponding 3-isocyanatopropyl alkyl dimethoxysilane may also be used, in which case the alkyl group may be a C₁₋₈ alkyl group. In addition, isocyanatomethyl dimethoxysilane or isocyanatomethyl trimethoxysilane may be used. In principle, the methoxysilanes may also be replaced by their ethoxy or propoxy analogs.

These production processes and the use of the above-mentioned silane-terminated prepolymers with a polyether backbone in adhesive/sealant applications are described, for example, in the following patent specifications: U.S. Pat. No. 3,971,751, U.S. Pat. No. 4,960,844, U.S. Pat. No. 3,979,344, U.S. Pat. No. 3,632,557, DE-A-4029504, EP-A-601021, EP-A-370464.

In the two-component adhesives/sealants according to the invention, component A contains a prepolymer containing silane groups, fillers, plasticizers, coupling agents, rheology aids, stabilizers, catalyst(s), pigments and other typical auxiliaries and additives. For this reason, component A may be used on its own as a one-component moisture-curing adhesive/sealant and achieves very high early strength, even immediately after the parts have been joined.

According to the invention, suitable prepolymers containing reactive silane groups (silane-terminated prepolymers) are, basically, any of the silane-terminated prepolymers described above, although the polymers containing alkoxysilane groups based on oxyalkylene polymers (polyoxyalkylene glycols) described for the first time in U.S. Pat. No. 3,971,751 are particularly preferred. These prepolymers are commercially available under the name of “MS Polymer” (from Kanegafuchi).

Alternatively or in addition to the above-mentioned oxyalkylene polymers mentioned above, the prepolymers containing reactive silane groups based on acrylate or methacrylate derivatives described, for example, in EP-A-265929 may be used as the prepolymers containing reactive silane groups.

Suitable plasticizers are any of the plasticizers typically used for adhesives/sealants, for example the various phthalic acid esters, arylsulfonic acid esters, alkyl and/or aryl phosphates and the dialkyl esters of aliphatic and aromatic dicarboxylic acids.

Suitable fillers and/or pigments are any of the usual coated or uncoated fillers and/or pigments, although they should preferably have a low water content. Examples of suitable fillers are powdered limestone, natural ground chalks (calcium carbonates or calcium-magnesium carbonates), precipitated chalks, talcum, mica, clays or heavy spar. Examples of suitable pigments are titanium dioxide, iron oxides and carbon black.

In a preferred embodiment, component A preferably contains low molecular weight alkoxysilane compounds such as, for example, 3-glycidoxypropyl trialkoxysilane, 3-acryloxypropyl trialkoxysilane, 3-aminopropyl trialkoxysilane, 1-aminoalkyl trialkoxysilane, α-methacryloxymethyl trialkoxysilane, vinyl trialkoxysilane, N-aminoethyl-3-aminopropylmethyl dialkoxysilane, phenylaminopropyl trialkoxysilane, aminoalkyl trialkoxysilane, i-butyl methoxysilane, N-(2-aminoethyl)-3-aminopropyl trialkoxysilane or mixtures thereof. Instead of the trialkoxysilane compounds mentioned above, the corresponding dialkoxysilane analogs may also be used, in which case an alkoxy group is replaced by a non-functional C₁₋₈ alkyl group. In addition, low molecular weight oligoalkoxysilanes of the above-mentioned low molecular weight alkoxysilane compounds oligomerized through the alkoxy group may be used. Mixtures of the low molecular weight alkoxysilane compounds mentioned above may also be used.

The alkoxy group may be a methoxy, ethoxy, propoxy, methoxy propylene glycol ether, ethylene propylene glycol ether or even a butoxy group or an even higher homologous alkoxy group, the methoxy and/or ethoxy derivatives being particularly preferred.

In addition, component A or B should contain a silanol condensation catalyst (hardening catalyst). Examples of such catalysts are esters of titanic acid, such as tetrabutyl titanate, tetrapropyl titanate, tin carboxylates, such as dibutyl tin dilaurate, dibutyl tin maleate, dibutyl tin diacetate, tin(II) octoate, tin naphthenate, tin(II) alkoxylates, dibutyl tin alkoxylates, dibutyl tin acetylacetonate, amino compounds, such as morpholine, N-methyl morpholine, 2-ethyl-2-methylimidazole, 1,8-diazabicyclo(5.4.0)undec-7-ene (DBU), carboxylic acid salts of these amines or long-chain aliphatic amines.

In addition, component A of the adhesives/sealants according to the invention may optionally contain additional stabilizers. “Stabilizers” in the context of the present invention are antioxidants, UV stabilizers and hydrolysis stabilizers. Examples of such stabilizers are the commercially available sterically hindered phenols and/or thioethers and/or substituted benzotriazoles and/or amines of the “HALS” (hindered amine light stabilizer) type.

Component B of the two-component adhesives/sealants according to the invention contains at least one silane-terminated prepolymer, water and water-dissolving or water-adsorbing agents. The silane-terminated prepolymer(s) are preferably the same as or similar to those of component A, i.e., both a prepolymer of the silane-terminated polyalkylene oxide type and a silane-functional prepolymer based on acrylates or methacrylates or even mixtures of the two polymer types may be used. Besides the silane-functional prepolymers, component B contains 1 to 20% by weight and preferably 3 to 15% by weight water, based on the total weight of component B. The water is preferably adsorbed onto inorganic thickeners or dissolved or swollen in organic thickeners.

Preferred thickeners for the preferred embodiment are water-soluble or water-swellable polymers or inorganic thickeners. Examples of organic natural thickeners are agar agar, carrageen, tragacanth, gum arabic, alginates, pectins, polyoses, guar flour, starch, dextrins, gelatine, casein. Examples of organic fully or partly synthetic thickeners are carboxymethyl cellulose, cellulose ethers, hydroxyethyl cellulose, hydroxypropyl cellulose, poly(meth)acrylic acid derivatives, polyvinyl ether, polyvinyl alcohol, polyamides, polyimines. Examples of inorganic thickeners or adsorbents for the water are polysilicic acids, highly disperse, pyrogenic hydrophilic silicas, clay minerals, such as montmorillonite, kaolinite, halloysite, aluminium hydroxide, aluminium oxide hydrate, aluminium silicates, talcum, quartz minerals, magnesium hydroxide or the like.

Both component A and component B may optionally contain typical rheology aids such as, for example, highly disperse silicas, bentones, urea derivatives, amide waxes, waxes, fibrillated or pulped short fibers and castor oil derivatives.

Component A and component B may be produced by conventional mixing processes known per se for paste-form compositions. They are preferably produced in evacuable mixing units in order to eliminate gas bubbles. The following mixing units are mentioned by way of example: planetary mixers, planetary dissolvers, kneaders or closed mixers.

In the same way as component A, component B may contain fillers, plasticizers, stabilizers, pigments and other auxiliaries and additives.

As mentioned above, the composition of component A according to the invention is such that it cures completely on its own and provides comparable ultimate strength values to the mixture of component A and component B. Since component B also contains reactive polymer, its reaction is also activated through the access of catalyst from component A to such an extent that component B is included in the crosslinking reaction. Accordingly, this adhesive system is largely unaffected by mixing and dosing errors between component A and component B, so that the ratio between components A and B can be varied within very broad limits without any adverse effect on the ultimate strength of the adhesive bond. This is a major advantage over conventional two-component adhesives/sealants. The advantage over one-component systems is that even bonds between nonporous substrates cure rapidly largely irrespective of the ambient air humidity. Component A is mixed with component B in a ratio of 1:5 to 5:1 parts by weight, preferably 1:2 to 2:1 parts by weight and more particularly 1:1 part by weight.

Surprisingly, the high water concentration in component B does not adversely affect the storage stability of component B which—on the contrary—is so good that hardly any premature hardening of the water-containing component B occurs. It is also surprising that the open time of a mixed two-component material of component A and component B does not decrease proportionally to the amount of water added in component B; quite to the contrary, it increases. This is a desirable effect because many of the hitherto known sealant and adhesive systems based on silane-modified polymers suffer from a very short open time. This is a disadvantage in the sealing or bonding of large workpieces because, with short open times before joining, the crosslinking reaction starts strongly, beginning with an increase in the viscosity of the binder. This increase in viscosity means a reduction in the wetting of the substrates, which, in general, can only be counteracted by increasing the pressure applied. In addition, there is no accelerated skinning with the two-component systems according to the invention.

As mentioned at the beginning, the adhesives/sealants according to the invention are additionally distinguished by the fact that the surfaces of most substrates do not have to be pretreated with a primer. This applies in particular to metallic substrates such as, for example, aluminium, eloxated aluminium, steel (particularly stainless steel), galvanized steels, pretreated (particularly phosphated) steels, copper, brass, glass, wood and a large number of plastics.

Accordingly, the adhesive/sealant compositions according to the invention may be used for the elastic bonding of two or more substrates of the same or different kind(s), as mentioned above, and are also suitable for the seam sealing or coating of structural components of the above-mentioned materials.

The invention is illustrated by the following Examples where all quantities are parts by weight, unless otherwise indicated.

### EXAMPLES

One component A and three embodiments of component B were mixed with intensive shearing in a planetary mixer, evacuated during mixing to remove gases and then packed in cartridges.

### Example 1

Component A had the composition shown in the following Table:

| Name | % |
|---|---|
| Prepolymer S303H (1) | 34.500% |
| Prepolymer SAT 10 (2) | 10.000% |
| Alkylsulfonic acid phenyl ester, Mesamoll (Bayer) | 1.300% |
| Bis-(2,2,6,6-tetramethyl-4-piperidyl sebacate) solution | 2.400% |
| Silica HDK N 20 (Wacker) | 1.870% |
| Chalk Socal U1S1 (Solvay) | 41.230% |
| Carbon black Monarch 580 (Cabot) | 1.000% |
| 3-Aminopropyl trimethoxysilane | 5.800% |
| 3-Glycidyloxypropyl trimethoxysilane | 1.400% |
| DBTB (di-n-butyl dibutoxy tin) | 0.500% |
| | 100.00% |

(1) dimethoxymethylsilyl-terminated polypropylene oxide ether (Kanegafuchi)
(2) difunctional polypropylene oxide ether with terminal dimethoxymethylsilyl groups (Kanegafuchi)

### Example 2

The compositions of the three B components are shown in the following Table:

| | Component | Component | Component |
|---|---|---|---|
| Name | B1 | B2 | B3 |
| MS Polymer S303H | 53.000% | 53.000% | 53.000% |
| Silikolloid P87 | 44.000% | 41.000% | 35.000% |
| (silica/kaolinite mixture) | | | |
| Water, demin. | 3.000% | 6.000% | 12.000% |
| | 100.000% | 100.000% | 100.000% |

The open time, i.e. the period of time for which the mixture of component A and component B remains further processible, was determined on the one hand 2 days after production and separate storage of the components and, on the other hand, after separate storage of the two components for 21 days at 50° C. as an indication of long-term storage stability of the two components when stored separately. As the following results show, the storage stability of the system surprisingly increases with increasing water content in component B.

| | | Open time (mins.) | Open time (mins.) |
|---|---|---|---|
| | | 2 d after production | after storage for 21 d/50° C. |
| A | B1 | 40 | 5 |
| A | B2 | 38 | 20 |
| A | B3 | 45 | 30-35 |

The following test results were obtained with the two-component system of component A and component B:

| | |
|---|---|
| Skinning time: | ca. 20 min. |
| Shore A¹⁾: | 60 |
| Shore A²⁾: | 60 |
| Tear strength¹⁾: | 3.1 Mpa |
| Breaking elongation¹⁾: | 125% |
| Early strength³⁾: | ca. 4 hours (after storage at 23° C.) |
| Open time³⁾: | 30 min. (at 23° C./40% rel. humidity) |

¹⁾After storage for 14 days in a standard conditioning atmosphere
²⁾After storage for 14 days in a standard conditioning atmosphere + storage for 14 days at 170° C.
³⁾As measured on Al99.5 in accordance with EN 1465; layer thickness: 2 mm; test speed: 20 mm/min.

The adhesive/sealant compositions according to the invention were no different in their UV and weathering resistance, heat resistance and adhesion retention from the known one-component adhesives/sealants based on silane-terminated polyoxypropylene glycols. In addition, they showed excellent adhesion on all metallic substrates and on glass and glass-fiber-reinforced plastics.

What is claimed is:

1. An adhesive/sealant composition comprising:
a) a component A comprising at least one silane-terminated prepolymer, at least one silane crosslinking catalyst, and at least one low molecular weight organofunctional silane; and
b) a component B comprising at least one silane-terminated prepolymer, water and at least one water-dissolving and/or water-adsorbing agent.

2. An adhesive/sealant composition as claimed in claim 1, wherein at least one of component A or component B is additionally comprised of at least one auxiliary selected from the group consisting of fillers, plasticizers, antiagers, and rheology aids.

3. An adhesive/sealant composition as claim 1, wherein component B is a paste-like, stable mixture of at least one silane-terminated prepolymer, at least one plasticizer, water, and at least one thickener.

4. An adhesive/sealant composition as claimed in claim 1, wherein at least one inorganic thickener selected from the group consisting of polysilicic acids, highly disperse pyrogenic silicas, aluminum hydroxide, aluminum oxide hydrate, talcum, quartz minerals, magnesium hydroxide, and clay minerals is present as water-dissolving and/or water-absorbing agent in component B.

5. An adhesive/sealant composition as claimed in claim 1, wherein at least one organic thickener selected from the group consisting of agar agar, carrageen, tragacanth, gum arabic, alginates, pectins, polyoses, guar gum, starch, dextrins, gelatine, casein, carboxymethyl cellulose, cellulose ethers, hydroxyethyl cellulose, hydroxypropyl cellulose, poly(meth)acrylic acid derivatives, polyvinyl ether, polyvinyl alcohol, polyamides, and polyimines is present as water-dissolving and/or water-absorbing agent in component B.

6. An adhesive/sealant composition as claimed in claim 1, wherein at least one organotin compound is used as a silane crosslinking catalyst.

7. An adhesive/sealant composition as claimed in claim 1, wherein the low molecular weight organofunctional silane is selected from the group consisting of 3-glycidyloxypropyl trialkoxysilanes, 3-acryloxypropyl trialkoxysilanes, 3-aminopropyl trialkoxysilanes, vinyl trialkoxysilanes, phenylaminopropyl trialkoxysilanes, aminoalkyl trialkoxysilanes, N-(2-aminoethyl)-3-aminopropyl trialkoxysilanes, 3-glycidyloxypropylalkyl dialkoxysilanes, 3-acryloxypropylalkyl dialkoxysilanes, 3-aminopropylalkyl dialkoxysilanes, vinylalkyl dialkoxysilanes, phenylaminopropylalkyl dialkoxysilanes, aminoalkylalkyl dialkoxydisilanes, N-(2-aminoethyl)-3-aminopropylalkyl dialkoxysilanes, i-butyl methoxysilane and mixtures thereof.

8. An adhesive/sealant composition as claimed in claim 1, wherein component B contains 1 to 20% by weight water, based on the total weight of component B.

9. An adhesive/sealant composition as claimed in claim 1, wherein component B contains 3 to 15% by weight water, based on the total weight of component B.

10. An adhesive/sealant composition as claimed in claim 1, wherein component A and component B are mixed in a ratio of 1:5 to 5:1 parts by weight.

11. An adhesive/sealant composition as claimed in claim 1, wherein component A and component B are mixed in a ratio of 1:2 to 2:1 parts by weight.

12. An adhesive/sealant composition as claimed in claim 1, wherein component A and component B are mixed in a ratio of 1:1 parts by weight.

13. An adhesive/sealant composition as claimed in claim 1, wherein said at least one silane-terminated prepolymer in component A and said at least one silane-terminated prepolymer in component B are selected from the group consisting of silane-terminated prepolymers with polyether backbones.

14. A method for bonding a first substrate and a second substrate using an adhesive, wherein said first substrate and said second substrate are the same or different, said method comprising using an adhesive/sealant composition as claimed in claim 1 as said adhesive.

15. A process for the primeness bonding of a first substrate and a second substrate, said first substrate and said second substrate being the same or different, said process comprising:
a) applying an adhesive/sealant composition as claimed in claim 1 to a surface of said first substrate;
b) placing said second substrate on said surface of said first substrate having said adhesive/sealant composition applied thereto; and
c) establishing a bond between said first substrate and said second substrate, wherein said bond can be rapidly further processed and/or transported without further mechanical fixing.

16. A process as claimed in claim 15, wherein component A and component B are mixed in a ratio of 1:5 to 5:1 parts by weight before step a).

17. A process as claimed in claim 15, wherein component A and component B are mixed in a ratio of 1:2 to 2:1 parts by weight before step a).

18. A process as claimed in claim 15, wherein component A and component B are mixed in a ratio of 1:1 parts by weight before step a).

19. A process as claimed in claim 15, wherein said first substrate and said second substrate are structural elements comprised of one or more materials selected from the group consisting of metals, painted metals, pretreated metals, glass, wood and plastics.

20. An adhesive/sealant composition comprising:
a) a component A comprising at least one silane-terminated prepolymer having a polyether backbone, at least one silane crosslinking catalyst selected from the group consisting of organotin compounds, and at least one low molecular weight organofunctional silane selected from the group consisting of 3-glycidyloxypropyl trialkoxysilanes, 3-acryloxypropyl trialkoxysilanes, 3-aminopropyl trialkoxysilanes, vinyl trialkoxysilanes, phenylaminopropyl trialkoxysilanes, aminoalkyl trialkoxysilanes, N-(2-aminoethyl)-3-aminopropyl trialkoxysilanes, 3-glycidyloxypropylalkyl dialkoxysilanes, 3-acryloxypropylalkyl dialkoxysilanes, 3-aminopropylalkyl dialkoxysilanes, vinylalkyl dialkoxysilanes, phenylaminopropylalkyl dialkoxysilanes, aminoalkylalkyl dialkoxydisilanes, N-(2-aminoethyl)-3-aminopropylalkyl dialkoxysilanes, and i-butyl methoxysilane; and
b) a component B comprising at least one silane-terminated prepolymer having a polyether backbone, 1 to 20 weight % water and at least one inorganic thickener selected from the group consisting of polysilicic acids, highly disperse pyrogenic silicas, aluminum hydroxide, aluminum oxide hydrate, talcum, quartz minerals, magnesium hydroxide, and clay minerals.
